(19) United States
(12) Patent Application Publication
(10) Pub. No.: US 2013/0334443 A1
(43) Pub. Date: Dec. 19, 2013

(54) RADIOPHARMACY AND DEVICES

(71) Applicants: Colin Steel, London (GB); Sajinder Kaur Luthra, Amersham (GB); Robin Fortt, London (GB); Farah Shah, Northwood (GB)

(72) Inventors: Colin Steel, London (GB); Sajinder Kaur Luthra, Amersham (GB); Robin Fortt, London (GB); Farah Shah, Northwood (GB)

(73) Assignee: GE HEALTHCARE LIMITED, LITTLE CHALFONT, BUCKINGHAM (GB)

(21) Appl. No.: 13/976,106

(22) PCT Filed: Dec. 22, 2011
(86) PCT No.: PCT/US11/66765

§ 371 Date: Jun. 26, 2013

Related U.S. Application Data
(60) Provisional application No. 61/427,231, filed on Dec. 27, 2010.

(51) Int. Cl. B65B 3/00; G21F 3/00

(52) U.S. Cl. CPC B65B 3/003; G21F 3/00
USPC 250/506.1; 250/515.1; 141/69; 141/82

(57) ABSTRACT

Components and systems for a PET radiopharmacy include a transport shield for a radioisotope cartridge, a cassette for dispensing from a transport shield, a cassette synthesis platform for a cassette, and a synthesizer shield.

### FIELD OF THE INVENTION

The present invention relates to the field of radiopharmaceuticals. More specifically, the present invention is directed to a low-cost radiopharmacy and related methods and devices.

### BACKGROUND OF THE INVENTION

In order to supply PET radiopharmaceuticals to emerging markets, the hardware/equipment required for manufacture ideally needs to be low cost and simple to operate whilst adhering to quality and safety regulations. Current PET radiopharmaceutical manufacture is costly and requires significant financial commitment in both facility and hardware. The cost is prohibitive for establishing a radiopharmaceutical distribution network, especially when considering emerging markets such as China or India.

There is therefore a need in the art for the set-up and operation of low cost PET radiopharmacies for the distribution of radiotracers within emerging markets. These may be based upon 3 differing concepts a) the manufacture and distribution of cyclotron produced radioisotope, such as [F-18]fluoride, on SPE cartridges b) the manufacture of PET radiotracers using simplified kit based methodologies c) manufacture of PET radiotracers within a low cost facility with minimal infrastructure.

### BRIEF DESCRIPTION OF THE DRAWINGS

FIG. 1 depicts a cross-sectional view of a transport shield for a microscale Solid Phase Extraction (SPE) [F-18]fluoride cartridge.

FIG. 2 is an oblique view of the assembled cartridge housing of FIG. 1.

FIG. 3 depicts an alternate transport shield for a microscale SPE [F-18]fluoride cartridge of the present invention.

FIG. 4 is an exploded view of the transport shield of FIG. 3.

FIG. 5 depicts a cross-section of the exploded view of the FIG. 4, depicting the insertion of a transport shield within the housing.

FIG. 6 depicts a cross-sectional view of the assembled transport shield of FIG. 3 containing a microscale SPE [F-18]fluoride cartridge.

FIG. 7 depicts a first PET radiopharmaceutical kit (with a [F-18]fluoride SPE cartridge attached) of the present invention.

FIG. 8 depicts a second PET radiopharmaceutical kit for a microscale SPE [F-18]fluoride cartridge, providing dual reactions in a single reaction vial, of the present invention.

FIG. 9 depicts a third PET radiopharmaceutical kit for a microscale SPE [F-18]fluoride cartridge, providing dual reactions in dual reaction vials, of the present invention.

FIG. 10 a synthesis platform for receiving a radiopharmaceutical kit of the present invention.

FIG. 11 depicts the synthesis platform of FIG. 10, with the cover removed to expose a cassette with a microscale SPE [F-18]fluoride cartridge positioned therein.

FIG. 12 depicts a kit-based radiopharmaceutical synthesis hardware within a laminar flow hood.

FIG. 13 is a close-up view of a radiopharmaceutical kit mounted to actuation hardware of the present invention.

### DETAILED DESCRIPTION OF THE PREFERRED EMBODIMENTS

The present invention provides for the set-up and operation of low-cost PET radiopharmacies for the distribution of radiotracers. The present invention is particularly suitable within emerging markets or wherever low-cost distribution of radiotracers is desired. The approach is to distribute only the isotope from a centralized location while the radiopharmaceutical itself is prepared locally to the scanning center using simple kit based preparations.

The present invention includes three components which may be combined. First, the present invention provides for the manufacture and distribution of cyclotron produced radioisotope on small SPE cartridges. Second, the present invention provides for the manufacture of PET radiotracers using simplified kit based methodologies. Third, the present invention provides for the manufacture of PET radiotracers within a low cost facility with minimal infrastructure.

### a) Manufacture and Distribution of Radioisotope Using Small SPE Cartridges

The transport shields of the present invention allow the use of small SPE cartridges within a compact shield structure. The transport shields of the present invention make the use of the radioisotope, such as [F-18]fluoride bound to a cartridge, more amenable to simplified automation and subsequent use with kits. A bulk fluoride may be diluted and sub-dispensed onto the SPE resin within cartridge 12 either in single or multiple patient doses, as required by customer. The sub-dispensing may be performed under sterile conditions to provide a ‘cleaner’ source of [F-18]fluoride. Additionally, the radioisotope bound to resin and retained within a sealed environment provides secondary containment for transportation purposes; preferable ‘secure’ containment method when compared to other solutions such as transportation of syringes or vial containers; and may eliminate the need for further containment for transportation purposes.

The main financial outlay for new radiopharmacies is typically the set-up and installation of a cyclotron to generate and sub-dispense a radioisotope solution. For example, the present invention may be used to distribute, by way of illustration and not of limitation, [F-18]fluoride. Since there is minimal processing involved, a greater proportion of the radioisotope can be processed and distributed to radiopharmacies with greater efficiency as compared to, for example, [F-18]FDG distribution, thus maximizing product potential.

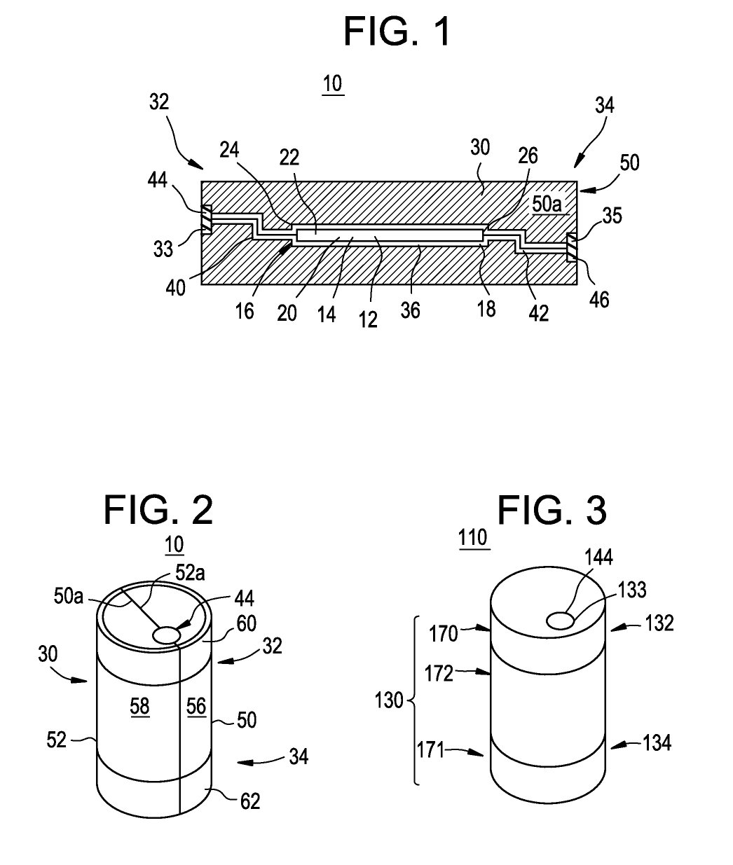

Referring to FIG. 1, the present invention provides a transport shield 10 for transporting a cartridge 12 on which is trapped a radioisotope. Cartridge 12 includes an elongate cylindrical wall 14 extending from a first open end 16 to a second open end 18 and which defines an elongate cartridge cavity 20 extending in fluid communication therebetween. A separations media 22 for trapping a radioisotope is positioned within cavity 20. The present invention contemplates that cartridge 12 may be in the form of a small SPE cartridge and may include a first porous filtration media 24 proximate first open end 16 and a second porous filtration media 26 proximate second open end 18 so as to hold media 22 therebetween. When cartridge 12 is a small SPE cartridge, it is contemplated that there will be end caps at each end of wall 20 for holding the filtration media in place, each end cap will define an aperture so as to allow fluid to flow through the cartridge. A radioisotope, such as [F-18]fluoride, is entrapped on media 22 when when an eluent with the radioisotope is flowed through cartridge 12. Alternatively, cartridge 12 may take the form of a nano-pak cartridge, as more fully described in commonly-assigned United States Patent Application No. 20090311157, entitled “NUCLEOPHILIC RADIOFLUORINATION USING MICROFABRICATED DEVICES” the entire contents of which are incorporated by reference as if fully disclosed herein. A nano-pak cartridge 12 includes an elongate tubular body having a first end defining an input port, a second end defining an output port, and an elongate passageway extending therebetween. The nano-pak includes a filter element spanning the passageway adjacent the output port and a resin is provided adjacent to the filter in the passageway.

Transport shield 10 includes an elongate shield body 30 formed from a radiation-shielding material, such as tungsten or lead. Shield body 30 includes a first end 32 defining a first port 33, a second end 34 defining a second port 35, and defines an elongate fluid channel 36 extending in open fluid communication therebetween. One portion of fluid channel 36 is defined by shield body 30 to be a cartridge passageway 38 for receiving cartridge 12 therein. Desirably, shield body 30 holds wall 14 of cartridge 12 in fluid-tight engagement within cartridge passageway 38 such that any fluid flowing through fluid channel 36 from first end 32 and second end 34 will be directed through cartridge cavity 20. The present invention further contemplates that cartridge 12 is surrounded by either co-extensive cylindrical gasket made from a suitable elastomeric material or includes an elastomeric gasket about both open ends 16 and 18 thereof so as to further assure that cartridge 12 is held in fluid-tightness by shield body 30 such that all eluent is directed through cartridge cavity 20. Fluid channel 36 also includes a first tortuous portion 40 and a second tortuous portion 42 on opposing ends of cartridge passageway 38. Tortuous portions 40 and 42 are designed to be non-linear so as to prevent a linear ‘shine path’ from cartridge cavity 20 which could directly expose an operator to the activity of a radioisotope entrapped in media 22. Desirably, cartridge 12 is centrally located within shield body 30, so as to maximize the effective shielding in radially away from the longitudinal axis of cartridge 12, and fluid channel 36 opens at either end of shield body 30 at locations radially-spaced from the longitudinal axis of cartridge 12.

Transport shield 10 desirably includes first and second self-sealing septums 44 and 46 positioned across port 33 and 35 at first end 32 and second end 34, respectively. Septums 44 and 46 are held in fluid-tight engagement across their respective port 33 and 35 and are formed from an elastomeric material which allows each to be pierced by an elongate needle or cannula so and to re-seal upon withdrawal of the needle or cannula.

With additional reference to FIG. 2, shield body 30 may be formed to include a first and second semi-cylindrical mating shells 50 and 52. The present invention contemplates shells 50 and 52 provide mating planar faces 50a and 52a, respectively, that are brought together when assembled. The present invention further contemplates that fluid channel 36 may be partially formed as depressions in each of planar faces 50a and 52a or may, alternatively, be formed as a depression in a single planar face 50a and 52a such that fluid channel 36 is fully defined when both shells are assembled together. Shells 50 and 52 are desirably held together by conventional means including, by way of illustration but not of limitation, an external locking band thereabout. The locking band may be either elastomeric such that it may be stretched to engage about the outer surfaces 56 and 58 of shells 50 and 52. Alternatively, the locking band may be a metallic ring positionable about outer surfaces 56 and 58. Alternatively still, as shown in FIG. 2, cylindrical surfaces 56 and 58 may define aligned helical threads which may be engaged by a threaded collars 60 and 62 at each of ends 32 and 34, respectively. The present invention further contemplates that solid endcaps (not shown) may be applied to transport shield 10 so as to securely cover over septums 42 and 44 and thereby provide a fully secure transport container for cartridge 12. The endcaps are contemplated to be threadably mateable to, or otherwise be conventionally connectable to, shield body 30.

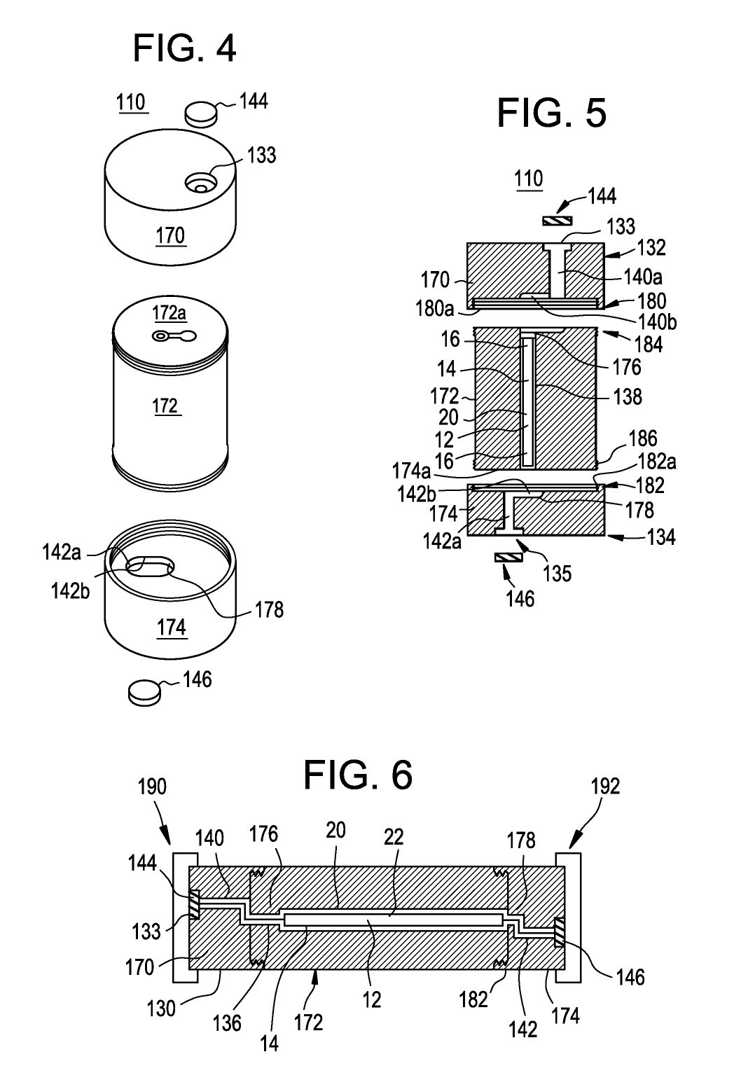

Referring now to FIGS. 3-6, the present invention also provides transport shield 110 for transporting a cartridge 12 on which is trapped a radioisotope. As will be described, transport shield 110 is similar to transport shield 10 but instead includes a shield body 130 formed from co-axially aligned shield body components 170, 172, and 174. As compared to transport shield 10, like numbering will indicate like parts.

Transport shield 110 includes an elongate shield body 130 formed from a radiation-shielding material, such as tungsten or lead. Shield body 130 includes a first end 132 defining a first port 133, a second end 134 defining a second port 135, and defines an elongate fluid channel 136 extending in open fluid communication therebetween. One portion of fluid channel 136 is defined by shield body 130 to be a cartridge passageway 138 for receiving cartridge 12 therein. Desirably, shield body holds wall 14 of cartridge 12 in fluid-tight engagement within cartridge passageway 138 such that any fluid flowing through fluid channel 136 from first end 132 and second end 134 will be directed through cartridge cavity 20. The present invention further contemplates that cartridge 12 is surrounded by either co-extensive cylindrical gasket made from a suitable elastomeric material or includes an elastomeric gasket about both open ends 16 and 18 thereof so as to further assure that cartridge 12 is held in fluid-tightness by shield body 130 such that an eluent will flow through cartridge cavity 20. Fluid channel 136 also includes a first tortuous portion 140 and a second tortuous portion 142 on opposing ends of cartridge passageway 138. Tortuous portions 140 and 142 are designed to be non-linear so as to prevent a linear ‘shine path’ from cartridge cavity 20 which could directly expose an operator to the activity of a radioisotope entrapped in media 22.

Transport shield 110 desirably includes first and second self-sealing septum 144 and 146 positioned across tortuous portions 140 and 142 at first port 133 and second port 135, respectively. Septums 144 and 136 are held in fluid-tight engagement across their respective port 133 and 135 and are formed from an elastomeric material which allows each to be pierced by an elongate needle or cannula so and to re-seal upon withdrawal of the needle or cannula.

Transport shield 110 is designed to provide cartridge 12 within shield component 172 which defines centrally-extending, or axially-extending, cartridge passageway 138 therein. Shield component 170 defines a longitudinally-extending acentric fluid path 140a which is radially off-set from cartridge passageway 138 of shield component 172. Fluid path 140a extends from a first end sealed by septum 144 and a second end opening in fluid communication with a radial channel 140b which extends from fluid path 140a to a second end in overlying registry with cartridge passageway 138 of shield component 172. When components 170 and 172 are assembled together, planar upper surface 172a covers over radial channel 140b of component 170 will define the radially-extending flowpath of tortuous portion 140 between fluid path 140a and cartridge passageway 138. Similarly, shield component 174 defines a longitudinally-extending acentric fluid path 142a which is radially off-set from cartridge passageway 138 of shield component 172. Fluid path 142a extends from a first end sealed by septum 146 and a second end opening in fluid communication with a radial channel 142b which extends from fluid path 142a to a second end in overlying registry with cartridge passageway 138 of shield component 172. When components 172 and 174 are assembled together, lower planar surface 174a covers over radial channel 142b of component 174 will define the radially-extending flowpath of tortuous portion 142 between fluid path 142a and cartridge passageway 138. The present invention contemplates that by having only components 170 and 174 defining the radial channel portions to be covered over by planar surfaces of component 172, dead-space may be minimized as there will be no risk of mis-aligning radially-extending channels of both end components 170 and 174 with radially-extending channels formed on the mating planar surfaces of component 172.

Furthermore, shield components 170 and 174 include an upstanding annular rim 180 and 182, respectively, which include inwardly-facing helical threads 180a and 182a, respectively, thereon. Shield component 172 includes outwardly-facing helical grooves 184 and 186 for mating engagement with threads 180a and 182a, respectively. Therefore, as shield components 170 and 174 are screwed to shield component 172, the tortuous portions 140 and 142 of fluid path 136 will be in fluid communication with the centrally-extending cartridge passageway 138 of component 172.

Component 172 desirably provides means for holding cartridge 12 within cartridge passageway 138. For example, the present invention contemplates that component 172 includes an annular shoulder 176 at one end of cartridge passageway 138 so as to engage cartridge wall 20 and maintain cartridge 12 within component 172. Similarly, component 174 desirably provides a semi-annular shoulder 178 to be positioned in underlying registry with cartridge wall 20 to maintain cartridge 12 within cartridge passageway 138. The semi-annular shape of shoulder 178 maintains fluid communication between cartridge passageway 138 and second tortuous portion 142 of fluid passageway 136. The present invention further contemplates that solid endcaps 190 and 192, shown in FIG. 6, may be applied to transport shield 110 so as to securely cover over septums 140 and 142 and thereby provide a fully secure transport container for cartridge 12. Endcaps 190 and 192 are contemplated to screw on to, or otherwise be conventionally connectable to, shield body 130.

### b) Manufacture of PET Radiotracers Using Simplified Kit Based Methodologies

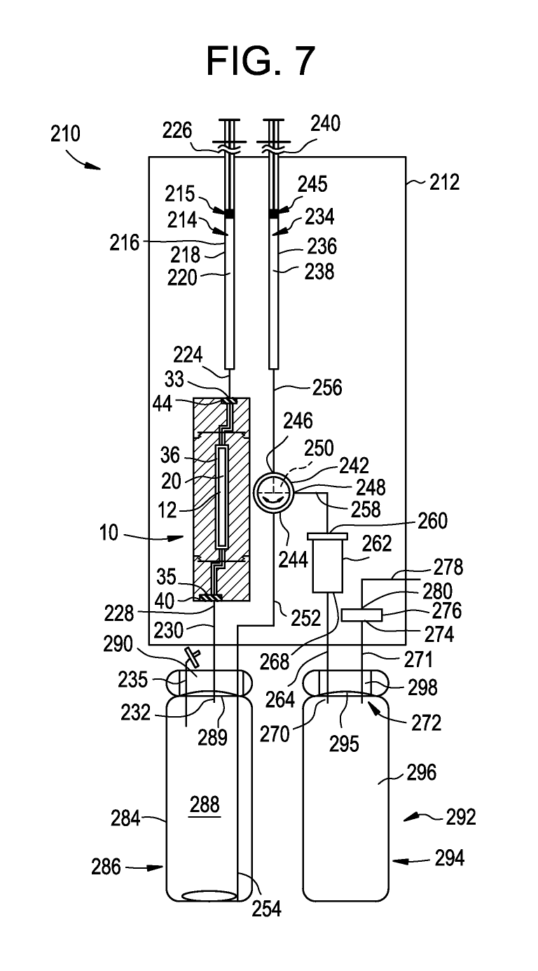

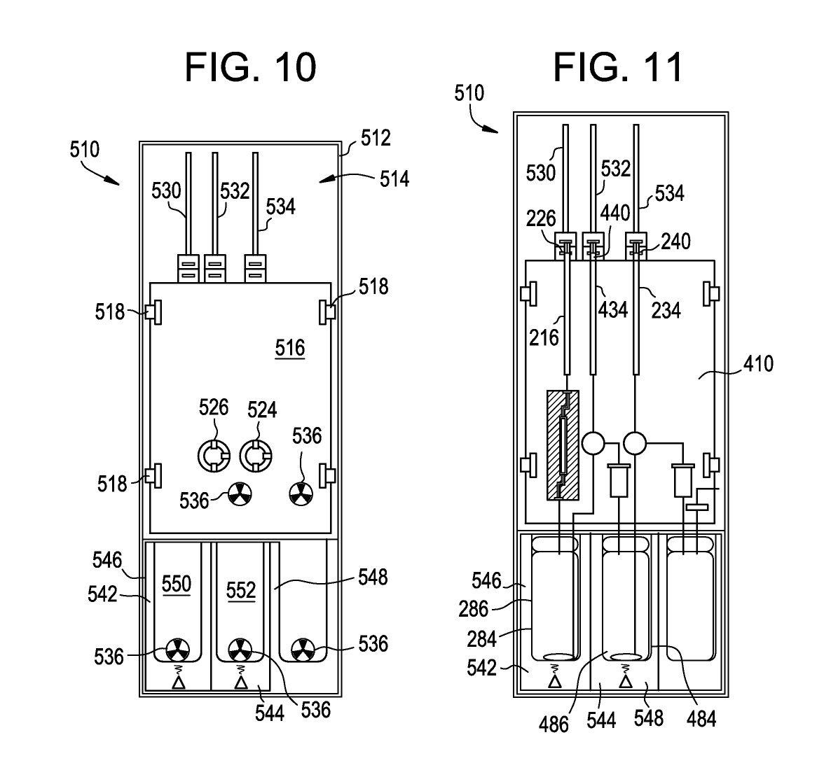

Suitable chemistry processes will enable simple 1- or 2-step radiosynthesis reactions to be conducted in conjunction with SPE purification using the transport shields of the present invention using a radiopharmaceutical kit, or cassette, of the present invention. The fully-assembled kits, or cassettes, will comprise single or dual reaction vials and a simple manifold which will include any required purification cartridges, valves or liquid motivation devices (e.g. syringes, pumps, or vacuum sources). Reagents and precursors will be provided pre-loaded in reaction vials where practicable (e.g. as freeze dried kits). FIGS. 7-9 depict examples of automatable hardware used to conduct a kit based PET nucleophillic radiolabelling reaction, although each could be configured for manual actuation. FIGS. 10 and 11 depict a syntheses platform for receiving the automatable hardware for operation by an actuation, or synthesis, unit.

The kits of the present invention enable the freeze dried reagents/reaction vials to be attached to the cassette as well as accepting the shielded SPE cartridge without exposing the operator to radioactive material. For example, the present invention allows the transfer of [F-18]fluoride from an SPE cartridge within a transport shield to a reaction vessel. A solution, typically a potassium carbonate/K222 mixture or suitable alternative, required to elute [F-18]fluoride is passed through the SPE cartridge to elute the [F-18]fluoride from the SPE cartridge. Motivation could be achieved by syringe, peristaltic pump, over pressure or vacuum applied downstream of the cartridge (the vacuum even be applied through or from the vial into which the eluate is directed).

The [F-18]fluoride/K+/K222 solution passes into a reaction vessel containing a suitable ‘freeze dried precursor’. Ideally a reaction will occur at room temperature, although the reaction solution may require some form of mixing/heating. It is envisaged that the reagents will utilize a form of solid phase/liquid reaction whereby reaction by-products are controlled to yield a relatively clean reaction product within the final reaction solution. Mixing may be achieved by agitation whilst thermal heating. Agitation may take the form of vibrating and thermal heating may be provided using heating elements. For example, a heating element could be positioned adjacent to or about the vial so as to provide heating of the reaction solution within the vial.

Where further processing is required (e.g. a deprotection reaction), a second reagent will be added to the labelled precursor where both steps of a radiolabelling reaction can be conducted in a single reaction vessel. Where this is not possible, due to reagent incompatibility or formation of undesirable side reactions, SPE purification may be required to enable the reaction mixture to be processed prior to addition of/to a second reagent. A number of options are available whereby normal or reverse phase SPE can be conducted with the processed reaction mixture being transferred back into the original reaction vessel or to a second reaction vessel. The final configuration of the kits of the present invention will be dependant upon the design and chemical processes to be conducted.

It is envisaged that the reagent kits will enable simple SPE purification to be conducted to yield the final purified product suitable for aseptic dispensing and use in human patients. Ideally, use of kit-based radiosynthesis will lead to simplified QC analyses based around radioTLC procedures as opposed to radioHPLC procedures.

The transport shields of the present invention can be designed to fit a cassette of the present invention for operation by a common synthesizer (actuation system).

FIG. 7 depicts a first cassette 210 for dispensing a radioisotope from a transport shield of the present invention, first into a reaction vial 284, and then into a collection vial 292. Cassette 210 provides for a single step, single reactor synthesis. Transport shield 10 of the present invention is depicted, although cassette 210 is also contemplated to work with transport shield 110 or any other transport shield according to the present invention. Cassette 210 includes support base 212 to which the kit components may be mounted or mated with. Base 212 supports transport shield 10 such that ports 33 and 35 may be placed in fluid communication with the kit components as herein described.

A first syringe 214 having an elongate cylindrical barrel 216 defining a syringe cavity 218 containing an eluent 220 is connected to first port 33 so that eluent 220 may be directed through port 33 into and through fluid passageway 36. Syringe 214 supports an elongate hollow needle 224 for piercing through septum 44 so as to place cavity 218 in fluid communication with cartridge cavity 20 within transport shield 10. Syringe 214 includes an elongate piston rod 226 supporting an elastomeric piston 215 for slideable fluid-tight engagement with barrel 216 inside cavity 218. Piston rod 226 may be driven into barrel cavity 218 to force the eluent fluid from syringe cavity 218 into fluid passageway 36 and through cartridge cavity 20. An elongate hollow eluate needle 228 is supported at one end of an elongate first fluid line 230 and pierces second septum 46. The opposing end of fluid line 230 supports a first fill needle 232.

Cassette 210 includes a second syringe 234 having an elongate cylindrical barrel 236 defining a syringe cavity 238. Syringe 214 includes an elongate piston rod 240 supporting an elastomeric piston 245 for slideable fluid-tight engagement with barrel 236 inside cavity 238. Piston rod 240 may be reciprocally driven within barrel cavity 238 so as to both draw a fluid into cavity 238 and to force a fluid out of cavity 238. Cassette 210 includes a three-way valve 242 to selectably place syringe cavity 238 in fluid communication with the cavities of either reaction vial 284 or collection vial 292 (through a purification cartridge) as further described hereinbelow.

Valve 242 includes a reaction port 244, a pump port 246, and a collection port 248. Valve 242 also includes a rotatable stopcock which defines a through passage 250 extending therethrough and which may place any two of the three ports of valve 242 in fluid communication with each other while isolating the third port. Where ports 244 and 246 are diametrically opposed across valve 242 and collection port 248 is located circumferentially midway therebetween, passage 250 may have a T-shape through the valve stopcock. Alternatively, if ports 244, 246 and 248 are equally-spaced about valve 242, passage 250 may be follow a linear path adiametrically through the valve stopcock.

An elongate reaction conduit 252 is connected to reaction port 244 at one end and to a draw needle 254 at the opposite end. An elongate pump conduit 256 is connected to pump port 246 at one end and to syringe 234 at the other such that syringe cavity 238 is in fluid communication with pump port 246. An elongate collection conduit 258 is connected to collection port 248 at one end and to an input port 260 of a separations cartridge 262 at the other end. Separations cartridge 262 is desirably an SPE cartridge with an appropriate separations media therein. A dispense conduit 264 is connected to an exit port 268 of cartridge 262 at one end and to a dispense needle 270 at the other end. Cassette 210 further includes a vent conduit 271 extending from a vent needle 272 at one end to an input port 274 of a filter 276 at the other. A filter outlet conduit 278 extends from filter outlet port 280 to an exit port 282 open to atmosphere.

Cassette 210 is connectable to reaction vial 284 and to collection vial 292. Reaction vial 284 includes an open vial body 286 defining a vial cavity 288 and supporting an elastomeric septum 290 across its opening 287. Reaction vial 284 may further support a conventional vent needle 235 extending through septum 290 into cavity 288 so as to allow air to escape as fluids are directed into or out of reaction vial 284. Fill needle desirably extends into cavity 288 beyond septum 290 only a short distance, sufficient to allow fluid to be directed into reaction vial 284. Draw needle 254 desirably extends deep into vial cavity so as to allow maximum withdrawal of reaction product fluid from cavity 288. Collection vial 292 includes an open vial body 294 defining a vial cavity 296 and supporting a septum 298 across its opening 295. Needles 270 and 272 are inserted through septum 290 of collection vial 284 so that cavity 288 is in fluid communication with both cartridge cavity 20 in transport shield 10 and with reaction port 244 of valve 242. Needles 270 and 272 desirably extend through septum 290 only a short distance, sufficient to allow fluid to flow into vial cavity 296 and air to be vented out needle 272. Reaction vial 284 desirably contains a suitable reagent or precursor for mixing and reacting with the eluate from cartridge 12 when eluent 220 is directed therethrough.

Eluate needle 228, first fluid line 230, first fill needle 232 together form a first fluid line extending between the second port of the transport shield 10 and reaction vial 284. Similarly, draw needle 254, reaction conduit 252, pump conduit 256, syringe cavity 238, collection conduit 258, separations cartridge 262, dispense conduit 264, and dispense needle 270 form a second fluid line extending from reaction vial 284 to collection vial 292.

Depressing piston rod 226 into cavity 218 of syringe 214 will direct the eluent through cartridge 20 and into cavity 288 of reaction vial 284. Post reaction, the reaction product may be drawn from cavity 288 by setting valve 242 so that reaction port 244 and pump port 246 are in fluid communication across passage 250 and then retracting piston rod 240 so as draw reaction product fluid into cavity 238. Valve 242 is then adjusted so that pump port 246 and collection port 248 are in fluid communication across passage 250 and piston rod 240 is extended into cavity 238. The fluid from cavity 238 will then be directed through separations cartridge 262 and the eluate therefrom will be directed into collection vial 292. Air within cavity 296 of vial 292 will be vented out though vent conduit 271, through filter 276 and to atmosphere. The present invention further contemplates that multiple reciprocal strokes by piston rod 242, in coordination with the proper settings of valve 242, may be performed to move the desired amount of reaction product fluid from reaction vial 284 to collection vial 292, the number of reciprocal strokes to be dictated by the volume of syringe cavity 238 and the desired dose to be delivered to vial 292.

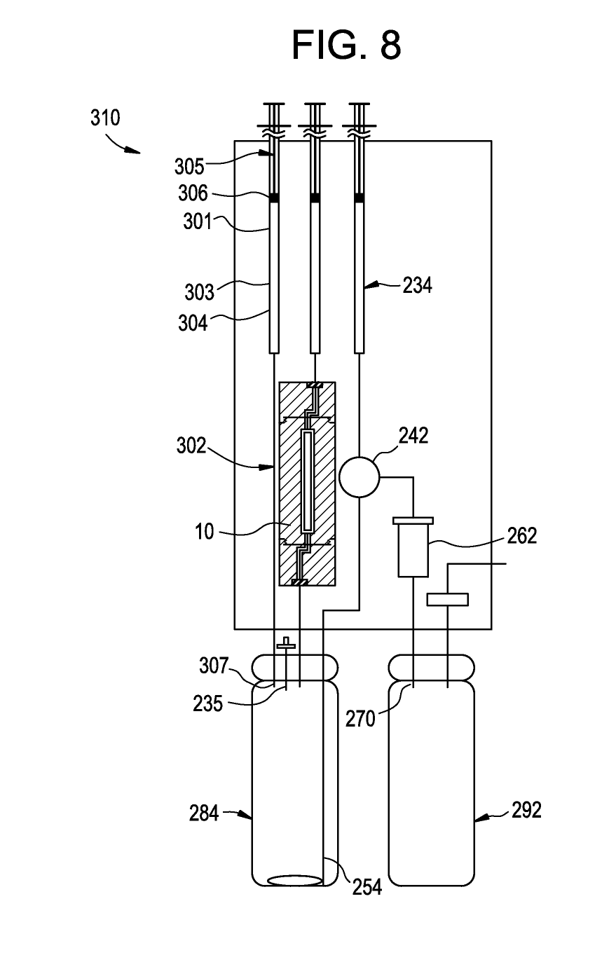

FIG. 8 depicts a second cassette 310 of the present invention. Cassette 310 is identical to cassette 210, except that it provides a third syringe 301 and reagent conduit 302 for providing a reagent to reaction chamber 284. Cassette 310 thus provides a two-step, single reactor synthesis device. Syringe 301 includes an elongate cylindrical barrel 303 defining a syringe cavity 304. Syringe 301 includes an elongate piston rod 305 supporting an elastomeric piston 306 for slideable fluid-tight engagement with barrel 303 inside cavity 304. Piston rod 305 may be driven within barrel cavity 238 to force a fluid out of cavity 304 and through conduit 302. Syringe 301 provides a second reagent or precursor within cavity 304 which can be added to reaction vial 284 either before or after the eluate from transfer shield 10 is introduced. Thus, cassette 310 can perform two reactions within a single reaction vial 284. After the reactions are complete, the contents of vial 284 are dispensed as described for cassette 210.

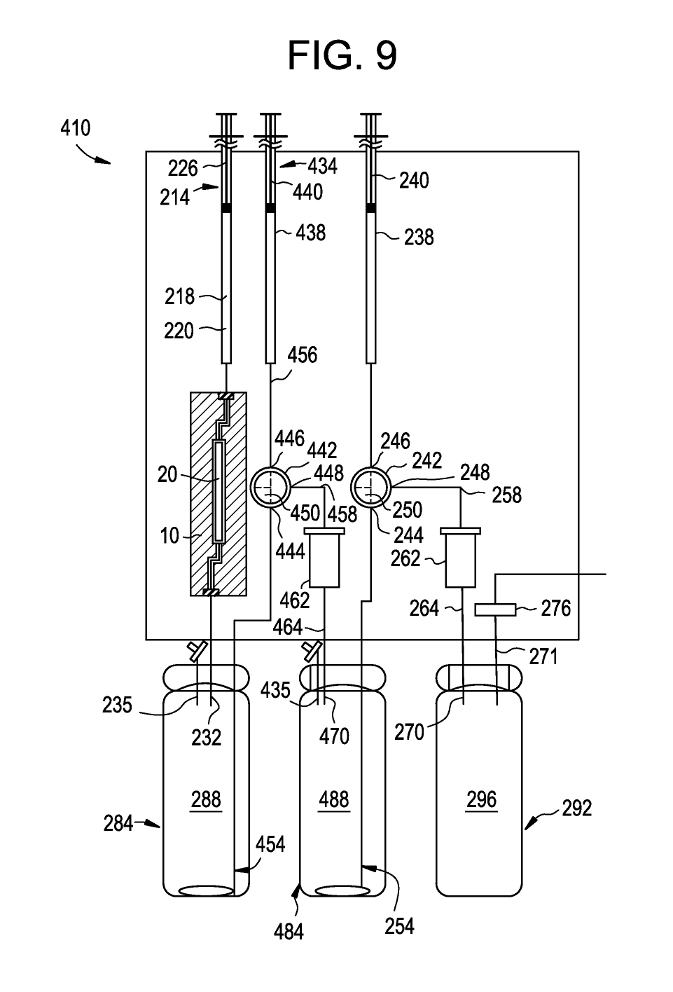

FIG. 9 depicts yet another cassette 410 of the present invention. Cassette 410 provides a two-step, dual reactor synthesis device, by providing for connection of a second reaction vial 484 and motive system along the fluid line from first reactor vial 284 to collection vial 292. Cassette 410 is thus similar to cassette 210 but adds a second draw needle 454, a second reaction conduit 452, a second valve 442, a second pump conduit 456, and a third syringe 434. Cassette 410 also provides an output conduit 458, a second a second separations cartridge 462, a second fill conduit 464, and a second fill needle 470 for transferring the reaction product fluid from the first reaction vial 284 to the second reaction vial 484. Second reaction vial 484 desirably includes a reagent or freeze-dried precursor. The reaction product fluid from vial 284 will flow through second separations cartridge 462 and the eluate therefrom will flow into second reaction vial 484 for mixing with the reagent (or precursor) to form a second reaction product fluid. The second reaction product fluid will be directed to the collection vial as previously described for the reaction product fluid of cassette 210.

Thus in operation, cassette 410 provides vial 284 connected at needles 232 and 454, vial 484 connected at needles 470 and 254, and vial 292 connected at needles 270 and 272. Depressing piston rod 226 into cavity 218 of syringe 214 will direct the eluent 220 through cartridge 20 into cavity 288 of reaction vial 284. Post reaction, the first reaction product fluid may be drawn from cavity 288 by setting valve 442 so that reaction port 444 and pump port 446 are in fluid communication across passage 450 and then retracting piston rod 440 so as draw the first reaction product fluid into cavity 438. Valve 442 is then adjusted so that pump port 446 and collection port 448 are in fluid communication across passage 450 and piston rod 440 is extended into cavity 438. The fluid from cavity 438 will then be directed through separations cartridge 462 and the eluate therefrom will be directed through conduit 464 and needle 470 into collection vial 484. Air within cavity 488 of vial 484 will desirably be vented out though vent needle 435. The eluate from cartridge 462 will then react with the reagent or precursor in vial 484 to form a second reaction product fluid. Multiple reciprocal strokes by piston rod 440, in coordination with the proper setting of valve 442, may be performed to move the desired amount of reaction product fluid from reaction vial 284 to reaction vial 484, the number of reciprocal strokes to be dictated by the volume of syringe cavity 438 and the desired volume to be delivered to vial 484.

After the second reaction, the second reaction product may be drawn from cavity 488 by setting valve 242 so that reaction port 244 and pump port 246 are in fluid communication across passage 250 and then retracting piston rod 240 so as draw the second reaction product fluid into cavity 238. Valve 242 is then adjusted so that pump port 246 and collection port 248 are in fluid communication across passage 250 and piston rod 240 is extended into cavity 238. The fluid from cavity 238 will then be directed through separations cartridge 262 and the eluate therefrom will be directed through conduit 264 and needle 270 into collection vial 292. Air within cavity 296 of vial 292 will be vented out though vent conduit 271, through filter 276 and to atmosphere. The present invention further contemplates that multiple reciprocal strokes by piston rod 240, in coordination with the proper setting of valve 242, may be performed to move the desired amount of reaction product fluid from reaction vial 284 to collection vial 292, the number of reciprocal strokes to be dictated by the volume of syringe cavity 238 and the desired dose to be delivered to vial 292.

Referring now to FIGS. 10 and 11, the present invention further provides a cassette synthesis platform 510 for a cassette with attached vials for performing the synthesis operation. Cassette synthesis platform 510 accommodates cassette 410, although the present invention further contemplates a cassette synthesis platform suitably adapted for any of the cassettes of the present invention. Cassette synthesis platform 510 includes a platform body 512 which defines a mounting aperture 514 into which cassette 410 is received. Cassette synthesis platform 510 includes a mounting plate 516 onto which base cassette base 212 is positioned. Desirably, mounting plate 516 incorporates suitable clamping mechanisms 518 for releasably retaining base 212. Mounting plate 516 incorporates valve actuators 524 and 526 which cooperatively engage the stopcocks of valves 242 and 442, respectively, to rotate their respective passages 250 and 450 into the required orientation during operation. Each of actuators 524 and 526 are desirably either electrically, electo-mechanically, mechanically (ie, also including fluidically) operable for causing rotation of the stopcocks.

Cassette synthesis platform 510 further provides syringe driver units 530, 532, and 534 for cooperatively engaging the piston rods 226, 440, and 240 of syringes 214, 434, and 234, respectively. Syringe driver units 530, 532, and 534 are envisioned to be either mechanical or electromechanical devices for moving respective piston rods 226, 440, and 240 within their syringe cavities 218, 438, and 238. For example, each syringe drive unit may include an electric motor whose rotation cause linear translation of piston rods 226, 440, and 240, respectively. Alternatively, each syringe drive unit may provide a mechanical connection to the syringe piston rod so that an external actuator will cause the translation of the piston rod. While driver unit 530 need only provide a single stroke to dispense the eluent contents of syringe 214, driver units 532 and 534 provide reciprocal motion of piston rods 440 and 240, respectively, to which they are engaged. Desirably, a radiation detector 536 is provided to detect activity in vials 284, 484, and 292 and in cartridges 462 and 262. Radiation detectors 536 desirably provide for connection to a synthesizer so that a signal indicative of the activity detected is recorded.

Cassette 520 further provides vial receptacles 542 and 544 for reaction vials 284 and 484, respectively. Receptacles 542 and 544 include elongate bodies 546 and 548 which define open cavities 550 and 552 for receiving vial body 286 and 486, respectively. Bodies 546 and 548 are desirably formed from a thermally-conductive material such as aluminum or copper to allow heat to be applied to the reaction vials as required. Additionally, bodies 546 and 548 desirably provide an interference fit which provides sliding engagement between the receptacle bodies and the vials so as to be able to transfer vibration to the vials, allowing agitation of the vial contents.

c) Manufacture of PET Radiotracers within a Low Cost Facility with Minimal Infrastructure

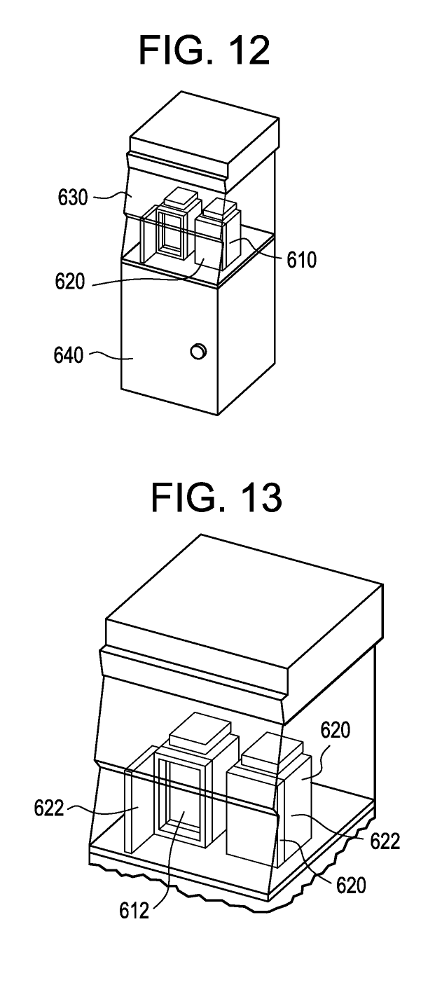

Referring now to FIGS. 12 and 13, the cassette synthesis platforms of the present invention, comprising the cassette with attached vials and the cassette synthesis platform, can be safely assembled and loaded onto a synthesizer 610. Synthesizer 610 cooperatively engages the syringe drives and valve actuators of the cassette synthesis platforms. Additionally, synthesizer 610 provides heat and vibration to receptacles 542 and 544 (or otherwise causes the heating and/or agitation) to aid in the reactions within vials 284 and 484. The clamping mechanism holds the cassette in place during radiosynthesis. Synthesizer 610 desirably includes an eject mechanism to eject the spent cassette from the platform after radiosynthesis. All reagent manipulation processes (syringe driver, valve actuation, heater and mixing/agitation) are conducted under computer control of synthesizer 610. Radioactive monitoring of each stage of the synthesis is also conducted for inclusion of data in a production batch record (along with other key items of data).

Synthesizer 610 is located within a laminar flow hood 630. Synthesizer 610 includes a platform-receiving face 612 on which platform 510 is mounted. Synthesizer 610 has a shielded enclosure 620 mounted over face 612 located within laminar flow hood 630. Enclosure 620 is formed from a radiation-shielding material for the safety of the operators and includes a hinged door 622 which is openable to allow access to synthesizer 610. Desirably, laminar flow hood 630 is mounted above a shielded waste containment area 640 within which spent platforms may be held until any residual activity has decayed to an acceptable level so as to allow removal by an operator. Desirably, enclosure 620 defines a drop-through aperture through which synthesizer 610 may automatically drop a spent and ejected cassette/platform. Platform 510 allows access to collection vial 292 so that it may be removed from cassette 410 prior to the platform being ejected by the synthesizer and dropped within the containment area.

The use of kit based radiosynthesis and associated simplified synthesis hardware negates the need to use standard lead shielded enclosures and GMP laboratory environment typically associated with PET radiosynthesis.

In a typical PET manufacturing facility, in order to maintain GMP regulatory requirements, the radiosynthesis should be conducted within a Class C environment, which is provided by the shielded enclosure. In this manner the shielded enclosure provides dual requirement of meeting both health and safety and quality requirements. However, to ensure health and safety requirements are met, the enclosure must provide extract and sufficient containment functionality to ensure that the level of radioactive material entering the environment is minimal or zero. This is typically provided by air handling units with appropriate air filtration and associated plant. Again, the air handling unit can provide a dual requirement in maintaining a Class C environment. Since the shielded enclosure is Class C, it must be housed within a Class C area to ensure the environment is contiguous when the shielded enclosure is entered. Additional air handling plant is required to maintain the laboratory environment. Overall, a significant level of equipment and plant is required to operate both the shielded enclosure and the laboratory and requires a significant investment in both cost and infrastructure. Obstacles such as these restrict opportunities to set-up radiopharmaceutical manufacturing sites, especially in emerging markets.

Use of the simplified kit based radiosynthesis of the present invention provides the potential to utilize a low cost solution whereby only the radioactive component of the radiosynthesis kit needs to be shielded, thus greatly reducing the size of the enclosure needed. With reference to FIGS. 12 and 13, the shielded enclosure can be attached to the hardware actuation apparatus and the whole system can now be housed within a laminar flowhood to provide a Class C environment. The shielded enclosure can be designed to be cleaned to meet Class C and linked to a separate waste containment system that can be housed within a shielded area below the laminar flow-hood. In this manner the overall infrastructure required to undertake radiopharmaceutical manufacture is reduced to a simple and low-cost alternative to current facility requirements.

While the particular embodiment of the present invention has been shown and described, it will be obvious to those skilled in the art that changes and modifications may be made without departing from the teachings of the invention. The matter set forth in the foregoing description and accompanying drawings is offered by way of illustration only and not as a limitation. The actual scope of the invention is intended to be defined in the following claims when viewed in their proper perspective based on the prior art.

What is claimed is:

1. A transport shield for a radioisotope, said transport shield comprising:
an elongate shield body having opposed first and second open ends and defining an elongate fluid passageway extending in fluid communication therebetween, said fluid passageway including a linearly-extending cartridge passageway and first and second tortuous portions, each said tortuous portion including a fluid path extending radially-spaced to said cartridge passageway.

2. A transport shield of claim 1, wherein said shield body further comprises mating semi-cylindrical shells which define said fluid passageway therebetween.

3. A transport shield of claim 1, wherein said shield body further comprises first, second, and third axially-aligned components, said first and third components each defining said fluid path extending radially-spaced to said cartridge passageway, and said second component defining said cartridge passageway.

4. A transport shield of claim 1, further comprising removable endcaps for the shield body, each said endcap positionable in overlying registry with opposed ends of said shield body.

5. A transport shield of claim 1, further comprising a radioisotope cartridge positioned within said cartridge passageway, said cartridge including a separations media in which a radioisotope is trapped.

6. A transport shield of claim 5, further comprising a gasket about said cartridge.

7. A transport shield of claim 5, further comprising a gasket about each end of said cartridge, positioned in said cartridge passageway between an outer wall of said cartridge and said shield body.

8. A transport shield of claim 3, wherein said first, second, and third components are threadably matable to each other.

9. A transport shield of claim 1, wherein said cartridge passageway extends centrally through said shield body.

10. A transport shield of claim 1, further comprising first and second septums sealing opposing ends of said fluid passageway.

11. A transport shield of claim 1, wherein said shield body is formed from one of lead and tungsten.

12. A transport shield of claim 2, further comprising a connection mechanism for holding said first and second shells together.

13. A cassette for dispensing from a transport shield of claim 1, comprising:
a source of eluent for connection to a first port of the transport shield;
a first reaction vial for connection to a second port of the transport shield;
a first elongate hollow fluid line extending between the second port of the transport shield and said first reaction vial;
a collection vial for collecting the radiopharmaceutical;
a separations cartridge;
a second elongate hollow fluid line extending between said first reaction vial and said collection vial, said separations cartridge positioned along said second fluid line to separate an eluate from a fluid drawn from said reaction vial;
a fluid motive systems for directing fluid from said source of eluent through a transport shield connected to said first fluid line, into said first reaction vial, and then through said separations cartridge into said collection vial.

14. A cassette of claim 13, further comprising a source of at least one of a reagent and a precursor connected to said first reaction vial.

15. A cassette of claim 13, further comprising:
a second reaction vial connected along said second fluid line between said first reaction vial and said separations cartridge; and
a second separations cartridge positioned along said second fluid line between said first and second reaction vials.

16. A cassette of claim 13, wherein said fluid motive system comprises a first syringe containing said source of eluent.

17. A cassette of claim 16, wherein said fluid motive system further comprises:
a second syringe; and
a first valve,
wherein said first valve is positioned along said second fluid line between said reaction vial and said separations cartridge, said second syringe is connected to said first valve, such that said first valve includes a first orientation for allowing said second syringe to draw fluid from therethrough from said reaction vial and a second position for allowing said second syringe to direct fluid therethrough and through said separations cartridge into said collection vial.

18. A cassette of claim 17, wherein said second syringe further comprises a source of at least one of a precursor and reagent for delivery to said first reaction vial.

19. A cassette of claim 15, wherein said fluid motive system further comprises:
a second syringe;
a third syringe;
a first valve; and
a second valve,
wherein said second valve is positioned along said second fluid line between said reaction vial and said second separations cartridge, said third syringe is connected to said second valve, such that said second valve includes a first orientation for allowing said third syringe to draw fluid from therethrough from said reaction vial and a second position for allowing said third syringe to direct fluid therethrough and through said second separations cartridge into said second reaction vial, and
wherein said first valve is positioned along said second fluid line between said second reaction vial and said separations cartridge, said second syringe is connected to said first valve, such that said first valve includes a first orientation for allowing said second syringe to draw fluid therethrough from said second reaction vial and a second orientation for allowing said second syringe to direct fluid therethrough and through said separations cartridge into said collection vial.

20. A cassette of claim 19, wherein said third syringe further comprises a source of at least one of a precursor and reagent for delivery to said first or second reaction vial.

21. A cassette adaptor for a cassette of claim 13, said cassette adaptor comprising:
an adaptor housing for receiving said cassette therein; and
a first cylindrical receptacle for receiving said first reaction vessel.

22. A cassette synthesis platform for a cassette of claim 17, further comprising:
a platform housing defining a cavity for receiving said cassette therein;
a first cylindrical receptacle for receiving said first reaction vessel;
a valve actuator for engaging said first valve, said valve actuator being operable to set the first valve to the first and second orientations;
a first and second syringe driver unit for engaging each of the first and second syringes, respectively, said first syringe driver unit being operable to cause said first syringe to expel the first eluent through a transport shield of claim 5 connected thereto and into the first reaction vessel, said second syringe driver unit being operable to cause said second syringe to draw a fluid thereto and to expel a fluid therefrom.

23. A cassette synthesis platform of claim 22, wherein said first cylindrical receptacle is formed from a radiation-shielding material.

24. A cassette synthesis platform of claim 23, wherein said first cylindrical receptacle is formed from a material with a high heat transmissivity

25. A cassette synthesis platform of claim 23, wherein said first cylindrical receptacle is shaped to transfer vibration applied to said receptacle to the reaction vial therein.

26. A cassette synthesis platform for a cassette of claim 19, further comprising:
a platform housing for receiving said cassette therein;
a first cylindrical receptacle for receiving said first reaction vessel;
a second cylindrical receptacle for receiving said second reaction vessel;
a first valve actuator for engaging said first valve, said first valve actuator being operable to set the first valve to the first and second orientations;
a second valve actuator for engaging said second valve, said second valve actuator being operable to set the second valve to the first and second orientations;
a first, second and third syringe driver unit for engaging each of the first, second and third syringes, respectively, said first syringe driver unit being operable to cause said first syringe to expel the first eluent through a transport shield of claim 5 connected thereto and into the first reaction vessel, said second and third syringe driver units being operable to cause said second and third syringe, respectively, to draw a fluid thereto and to expel a fluid therefrom.

27. A cassette synthesis platform of claim 26, wherein said first and second cylindrical receptacles are formed from a radiation-shielding material.

28. A cassette synthesis platform of claim 27, wherein said first and second cylindrical receptacles are formed from a material with a high heat transmissivity

29. A cassette synthesis platform of claim 27, wherein said first and second cylindrical receptacles are shaped to transfer vibration applied thereto to said respective first and second reaction vial therein.

30. A radiopharmaceutical synthesizer comprising the means to cause operation of each valve actuator and syringe driver unit of a cassette of either of claims 22 or 26 according to a pre-planned schedule.

31. A radiopharmaceutical synthesizer of claim 30, further comprising the means to apply one of heat and vibration to each said receptacle of a cassette of either of claims 22 or 26.

32. A synthesizer shield for a cassette-based radiopharmaceutical synthesizer, said synthesizer shield comprising a shield body to fit over and about a front face of the synthesizer so as to allow a synthesis cassette to be mounted to the synthesizer, said shield body further comprising an access door moveable between an open position allowing a cassette to be mounted to the synthesizer front face and a closed position enclosing the cassette while mounted on the front face.
